(19) United States
(12) Patent Application Publication
(10) Pub. No.: US 2014/0348222 A1
(43) Pub. Date: Nov. 27, 2014

(54) Method of Sample Adaptive Offset Processing for Video Coding and Inter-Layer Scalable Coding

(71) Applicant: MEDIATEK INC., Hsin-Chu (TW)

(72) Inventors: Shih-Ta Hsiang, New Taipei (TW); Chih-Ming Fu, Hsinchu (TW)

(73) Assignee: MEDIATEK INC., Hsin-Chu (TW)

(21) Appl. No.: 14/277,798

(22) Filed: May 15, 2014

Related U.S. Application Data
(60) Provisional application No. 61/826,741, filed on May 23, 2013.

(51) Int. Cl. H04N 19/31; H04N 19/51; H04N 19/105

(52) U.S. Cl. CPC H04N 19/0043; H04N 19/00024; H04N 19/00587
USPC 375/240.02

(57) ABSTRACT

A method of SAO (sample-adaptive offset) processing is disclosed, where EO classification is based on a composite EO type group. The composite EO type group comprises at least one first EO type from a first EO type group and at least one second EO type from a second EO type group. The first EO type group determines the EO classification based on the current reconstructed pixel and two neighboring reconstructed pixels, and the second EO type group determines the EO classification based on weighted outputs of the current reconstructed pixel and a number of neighboring reconstructed pixels. A method of inter-layer SAO processing is also disclosed. An inter-layer reference picture for an enhancement layer is generated from the BL reconstructed picture and the inter-layer SAO information is determined, where at least a portion of the inter-layer SAO information is predicted or re-used from the BL SAO information.

### CROSS REFERENCE TO RELATED APPLICATIONS

The present invention claims priority to U.S. Provisional Patent Application Ser. No. 61/826,741, filed May 23, 2013, entitled “Method and Apparatus for Image and Video Coding with Sample-Adaptive Offset Processing”. The U.S. Provisional Patent Application is hereby incorporated by reference in its entirety.

### FIELD OF THE INVENTION

The present invention relates to sample adaptive offset (SAO) processing. In particular, the present invention relates to SAO processing using inter-layer SAO parameter prediction/re-use for scalable coding, Edge Offset (EO) classification using a composite EO type group, and simplified scalability via SAO processing.

### BACKGROUND AND RELATED ART

Compressed digital video has been widely used in various applications such as video streaming over digital networks and video transmission over digital channels. Very often, a single video content may be delivered over networks with different characteristics. For example, a live sport event may be carried in a high-bandwidth streaming format over broadband networks for premium video service. In such applications, the compressed video usually preserves high resolution and high quality so that the video content is suited for high-definition devices such as an HDTV or a high resolution LCD display. The same content may also be carried through cellular data network so that the content can be watch on a portable device such as a smart phone or a network-connected portable media device. In such applications, due to the network bandwidth concerns as well as the typical low-resolution display on the smart phone or portable devices, the video content usually is compressed into lower resolution and lower bitrates. Therefore, for different network environment and for different applications, the video resolution and video quality requirements are quite different. Even for the same type of network, users may experience different available bandwidths due to different network infrastructure and network traffic condition. Therefore, a user may desire to receive the video at higher quality when the available bandwidth is high and receive a lower-quality, but smooth, video when the network congestion occurs. In another scenario, a high-end media player can handle high-resolution and high bitrate compressed video while a low-cost media player is only capable of handling low-resolution and low bitrate compressed video due to limited computational resources. Accordingly, it is desirable to construct the compressed video in a scalable manner so that videos at different spatial-temporal resolution and/or quality can be derived from the same compressed bitstream.

The joint video team (JVT) of ISO/IEC MPEG and ITU-T VCEG standardized a Scalable Video Coding (SVC) extension of the H.264/AVC standard. An H.264/AVC SVC bitstream can contain video information from low frame-rate, low resolution, and low quality to high frame rate, high definition, and high quality. Furthermore, efforts to extend the High Efficiency Video Coding (HEVC) to cover scalable video coding are also being undertaken by the Joint Collaborative Team on Video Coding (JCT-VC), and SHVC (Scalable Extension of HEVC) is being developed. The single bitstream can be adapted to various applications and displayed on devices with different configurations. Accordingly, H.264/AVC SVC are SHVC are suitable for various video applications such as video broadcasting, video streaming, and video surveillance to adapt to network infrastructure, traffic condition, user preference, and etc.

In SVC or SHVC, three types of scalabilities, i.e., temporal scalability, spatial scalability, and quality scalability, are provided. SVC uses multi-layer coding structure to realize the three dimensions of scalability. A main goal of SVC is to generate one scalable bitstream that can be easily and rapidly adapted to the bit-rate requirement associated with various transmission channels, diverse display capabilities, and different computational resources without trans-coding or re-encoding. An important feature of the SVC design is that the scalability is provided at a bitstream level. In other words, bitstreams for deriving video with a reduced spatial and/or temporal resolution can be simply obtained by extracting Network Abstraction Layer (NAL) units (or network packets) from a scalable bitstream that are required for decoding the intended video. NAL units for quality refinement can be additionally truncated in order to reduce the bit-rate and the associated video quality.

In SVC, the reconstructed BL (base layer) samples are up-sampled to generate the predictor for collocated EL (enhancement layer) samples, as shown in FIG. 1. The inter-layer prediction process comprises identifying the collocated block in the lower layer (e.g. BL) based on the location of a corresponding EL block and interpolating the collocated lower layer block to generate prediction samples for the EL as shown in FIG. 1. In scalable video coding, the interpolation process is used for inter-layer prediction by using predefined coefficients to generate the prediction samples for the EL based on the lower layer pixels.

The example in FIG. 1 consists of two layers. However, an SVC system may consist of more than two layers. The BL picture is formed by applying spatial decimation 110 to the input picture. Nevertheless, when the enhancement layer is coded at higher quality level with the same resolution, the spatial decimation (110) is not necessary. The BL can be coded based on a standard compatible coding system. For example, in the HEVC (High Efficiency Video Coding) based SVC (SHVC), the coding for the BL is compatible to the existing HEVC Main profile. The BL processing comprises BL prediction 120. The BL input is predicted by BL prediction 120, where subtractor 122 is used to form the difference between the BL input data and the BL prediction. The output of subtractor 122 corresponds to the BL prediction residues and the residues are processed by transform/quantization (T/Q) 130 and entropy coding 170 to generate compressed bitstream for the BL. Reconstructed BL data has to be generated at the BL in order to form BL prediction. Accordingly, inverse transform/inverse quantization (IT/IQ) 140 is used to recover the BL residues. The recovered BL residues and the BL prediction data are combined using reconstruction 150 to form reconstructed BL data. The reconstructed BL data is processed by in-loop filter 160 before it is stored in buffers. In the BL processing, BL prediction 120 uses Inter/Intra prediction 121. The EL processing consists of similar processing modules as the BL processing. The EL processing comprises EL prediction 125, subtractor 128, T/Q 135, entropy coding 175, IT/IQ 145, reconstruction 155 and in-loop filter 165. However, the EL prediction also utilizes reconstructed BL data as inter-layer prediction. Accordingly, EL prediction 125 comprises inter-layer prediction 127 in addition to Inter/Intra prediction 126. The reconstructed BL data is interpolated using interpolation 114 before it is used for inter-layer prediction. However, when the enhancement layer is coded at higher quality level with the same resolution, the spatial decimation (110) is not necessary. The BL can be based on a standard compatible coding system. The compressed bitstreams from the BL and the EL are combined using multiplexer 180.

Sample Adaptive Offset (SAO)

In the HEVC standard, the sample-adaptive offset (SAO) processing is utilized to reduce the distortion of reconstructed pictures. FIG. 2 illustrates a system block diagram of an exemplary HEVC-based decoder including deblocking filter (DF) and SAO. Since the encoder also contains a local decoder for reconstructing the video data, some decoder components are also used in the encoder. For a decoder, entropy decoder 222 is used to parse and recover the coded syntax elements related to residues, motion information and other control data. The switch 214 selects intra-prediction or inter-prediction and the selected prediction data are supplied to reconstruction (REC) 228 to be combined with recovered residues. Besides performing entropy decoding on compressed video data, entropy decoding 222 is also responsible for entropy decoding of side information and provides the side information to respective blocks. For example, intra mode information is provided to intra-prediction 210, inter mode information is provided to motion compensation 212, sample-adaptive offset information is provided to SAO 232 and residues are provided to inverse quantization 224. The residues are processed by IQ 224, IT 226 and subsequent reconstruction process to reconstruct the video data. Again, reconstructed video data from REC 228 undergo a series of processing including IQ 224 and IT 226 as shown in FIG. 2 and are subject to intensity shift. The reconstructed video data are further processed by deblocking filter 230 and sample adaptive offset 232.

The concept of SAO is to classify the reconstructed pixels into categories according to their neighboring pixel values. Each category is then assigned an offset value coded in the bitstream and the distortion of the reconstructed signal is reduced by adding the offset to the reconstructed pixels in each category. In the HEVC standard, the SAO tool supports two kinds of pixel classification methods: band offset (BO) and edge offset (EO).

For BO, the reconstructed pixels are classified into bands by quantizing the pixel magnitude, as shown in FIG. 3. An offset value can then be derived for each band to reduce the distortion of the reconstructed pixels in the band. A group of offsets identified by the starting band position are selected and coded into the bitstream. For EO, the reconstructed pixels are classified into categories by comparing the current pixel with its neighboring pixels along the direction identified by the EO type as shown in FIG. 4. Table 1 lists the decision for the EO pixel classification according to HEVC, where “c” denotes a current pixel to be classified. The category index, cat_idx, for the current pixel “c” is determined by

cat_idx=sign(c−c₁)+sign(c−c₋₁)+2, where (1)

$$sign ( x ) = \{ \begin{matrix}1 & ; & x > 0 \\ 0 & ; & x = 0 \\ - 1 & ; & x < 0 ,\end{matrix}$$

where “c₁” and “c₋₁” are the neighboring pixels corresponding to a given EO type as shown in FIG. 4. The four EO types with selections of neighboring pixels for different orientations are also shown in FIG. 4. An offset value is derived for all pixels in each category. Four offset values corresponding to category indices 1-4 respectively, are coded for one coding tree block (CTB) in HEVC.

TABLE 1

| Category | Condition |
|---|---|
| 1 | C < two neighbors |
| 2 | C < one neighbor && C == one neighbor |
| 3 | C > one neighbor && C == one neighbor |
| 4 | C > two neighbors |
| 0 | None of the above |

For each color component (luma or chroma), the SAO algorithm can divide a picture into non-overlapped regions, and each region can select one SAO type among BO (with starting band position), four EO types (classes), and no processing (OFF). The SAO partitioning can be aligned with the CTB boundaries to facilitate the CTB-based processing. The total number of offset values in one picture depends on the number of region partitions and the SAO type selected by each region.

The sample-adaptive offset (SAO) processing can also be employed to improve inter-layer texture prediction in a scalable video coding system. In this case, the SAO processing is utilized to reduce the distortion of the reconstructed BL pictures after interpolation operation, as illustrated in FIG. 5. Compared to a previous SVC system shown in FIG. 1, the inter-layer SAO (510) can be applied to interpolated reconstructed base layer from interpolation filter 114. Associated SAO information will be coded by entropy coding 520 and the compressed information will be incorporated into a scalable bitstream by multiplexer 180.

Recently, a method was disclosed for inter-layer SAO processing in a scalable HEVC system by G. Laroche, et al. (Joint Collaborative Team on Video Coding (JCT-VC) of ITU-T SG 16 WP 3 and ISO/IEC JTC 1/SC 29/WG 11 13th Meeting: Incheon, KR, 18-26 Apr. 2013, Document: JCTVC-M0114). The method of Laroche applies two cascaded SAO processing stages to the reconstructed picture from the decoded base layer or after up-sampling in case of spatial scalable coding. Each stage encodes three sets of SAO parameters, each for processing one color component in a picture. The method also utilizes the four EO types having the same orientations as the current HEVC EO. However, the category index, cat_idx, for each EO type is determined according to:

cat_idx=sign(((2*c−c₋₁−c₁+2)>>2)−((2*c₁−c−c₂+2)>>2))+sign(((2*c−c₋₁−c₁+2)>>2)−((2*c₋₁−c₋₂−c+2)>>2))+2, (2)

where “x>>2” operation means right shifting the number x by 2 bits. The orientations of the pixel classification method for the EO types are the same as HEVC. The operations corresponding to eqn. (2) can be considered as applying the highpass filtering to the reconstructed pixels with filter coefficients (−1, 2, −1)/4. A first difference of highpass outputs at c and c₋₁ is determined and a second difference of highpass outputs at c and c₁ is also determined. The signs of these two differences are added to form cat_idx. Due to the highpass filtering operation, four neighboring pixels are effectively employed for pixel classification for each EO type. FIG. 6 shows the reconstructed current pixels and its reconstructed neighboring pixels employed for pixel classification.

In HEVC, a picture is divided into multiple non-overlapped Coding Tree Units (CTUs), each CTU consists of multiple CTBs and each CTB is for one color component. Each CTB can select no processing (SAO-off) or apply one of SAO types or classes (i.e., BO with starting band position index, 0-degree EO, 90-degree EO, 135-degree EO, and 45-degree EO). To further reduce side-information, SAO parameters of a current CTB can reuse those of its upper or left CTB by using Merge syntax as shown in FIG. 7. SAO syntax consists of sao_merge_left_flag, sao_merge_up_flag, sao_type_idx_luma, sao_type_idx_chroma, sao_eo_class_luma, sao_eo_class_chroma, sao_band_position, sao_offset_abs, and sao_offset_sign. Syntax sao_merge_left_flag indicates that the current CTB reuses the parameters of left CTB. The syntax sao_merge_up_flag represents that the current CTB reuses the parameters of upper CTB. The syntax sao_type_idx represents the selected SAO type (i.e., sao_type_idx_luma and sao_type_idx_chroma for luma component and chroma component respectively). The syntax sao_eo_class_luma and sao_eo_class_chroma represent the selected EO type for luma and chroma respectively. The syntax sao_band_position represents the starting band position of the selected bands. The syntax sao_offset_abs represents the offset magnitude and the syntax sao_offset_sign represents the offset sign. cIdx indicates one of three color components. FIG. 8 illustrates the coding process for the CTU-level SAO information when the current CTU is not merged with the left or above CTU. Note that EO classes and band position is a kind of sub-class or sub-type to describe the SAO type information.

As shown in FIG. 8, the SAO type decision is made in step 810. If it is an EO type, the unsigned luma offsets (812) and luma EO class (814) are coded in the bitstream. If the SAO type is BO, signed luma offset (816) and luma band position (818) are coded in the bitstream. If SAO type is off, no other SAO information is signaled and the process goes to step 820. Similar SAO information for the chroma components follow. If the chroma components select EO, the unsigned Cb offsets (822), chroma EO class (824) and unsigned Cr offsets (826) are signaled. If the chroma components select BO, the signed Cb offsets (832), Cb band position (834), signed Cr offsets (836) and Cb band position (838) are signaled. The SAO type is off for the chroma components, no other SAO information is signaled and the process goes to step 840.

### BRIEF SUMMARY OF THE INVENTION

A method of SAO (sample-adaptive offset) processing for a reconstructed picture in a single-layer video coding system and a scalable video coding system is disclosed, where EO classification is based on a composite EO type group. The composite EO type group comprises at least one first EO type from a first EO type group and at least one second EO type from a second EO type group. The first EO type group determines the EO classification based on the current reconstructed pixel and two neighboring reconstructed pixels, and the second EO type group determines the EO classification based on weighted outputs of the current reconstructed pixel and a number of neighboring reconstructed pixels. The reconstructed picture can be divided into non-overlapped regions and SAO parameter set associated with the SAO processing for each region is signaling in a video bitstream. The region may correspond to an entire picture or a CTB (coding tree block), or the region corresponds to a quadtree partition region when the reconstructed picture is divided using quadtree partition. The reconstructed picture may correspond to a base layer picture or an enhancement layer picture, and SAO-processed reconstructed picture is stored in a decoded picture buffer for motion-compensated temporal prediction in the scalable video coding system. The reconstructed picture may correspond to a base layer picture or an enhancement layer picture before or after re-sampling for inter-layer prediction in a next enhancement layer in the scalable video coding system.

The weighted outputs may correspond to high-pass filtering outputs having scaled filter coefficients corresponding to (−1, 2, 1) or (−1, 1) and the weighted outputs use the current reconstructed pixel and four neighboring reconstructed pixels. The composite EO type group may include four first EO types from the first EO type group and four second EO types from the second EO type group, wherein the four first EO types and the four second EO types correspond to pixel patterns in 0°, 90°, 45° and 135° directions. The composite EO type group may also include two first EO types from the first EO type group and two second EO types from the second EO type group, wherein the two first EO types correspond to pixel patterns in 45° and 135° directions and the two second EO types correspond to pixel patterns in 0° and 90° directions.

A syntax flag can be signaled to indicate whether the composite EO type is selected from the first EO type group or the second EO type group in a corresponding coding structure. The syntax flag can be signaled in a video parameter set, sequence parameter set (SPS), picture parameter set (PPS), slice header or coding tree block (CTB).

A method of inter-layer sample-adaptive offset (SAO) processing using inter-layer SAO parameter prediction or re-using in a scalable video coding is also disclosed. An inter-layer reference picture for an enhancement layer is generated from the BL reconstructed picture. The inter-layer SAO information associated with the inter-layer reference picture is determined, wherein at least a portion of the inter-layer SAO information is predicted or re-used from the BL SAO information. The BL reconstructed picture can be divided into BL regions and the inter-layer reference picture is also divided into corresponding inter-layer regions corresponding to the BL regions. If a first BL region is merged with a second BL region to share the BL SAO information of the second BL region, a corresponding first inter-layer region can be merged with a corresponding second inter-layer region to share the inter-layer SAO information of the corresponding second inter-layer region. The BL region may correspond to an entire BL picture, a BL coding tree block (CTB) or a 4×4 block and the corresponding inter-layer region corresponds to an entire EL picture, an EL coding tree block (CTB) or an 4X×4X block, wherein X corresponds to a scaling factor between the enhancement layer and the base layer. In one embodiment, a syntax flag to enable/disable SAO parameter prediction or reusing is explicitly signaled, wherein the syntax flag is signaled in sequence parameter set (SPS), video parameter set, picture parameter set (PPS), slice header or coding tree block (CTB). In another embodiment, a syntax element is signaled to indicate which layer is used for the inter-layer SAO parameter prediction or re-using, wherein the syntax element is signaled in sequence parameter set (SPS), video parameter set, picture parameter set (PPS), slice header or coding tree block (CTB). In yet another embodiment, only partial inter-layer SAO information is predicted or re-used from the BL SAO information, wherein the partial inter-layer SAO information corresponds to inter-layer SAO merging syntax element, inter-layer SAO type, inter-layer SAO offset values, or any combination thereof. Furthermore, the BL SAO information can be stored in a compressed form for the inter-layer SAO parameter prediction or re-using. For example, the BL SAO information can be compressed by sub-sampling, wherein representative BL SAO information for one BL region is shared by every N BL regions and N is an integer greater than 1. When the BL SAO information is stored, only partial BL SAO information may be stored.

The present invention also discloses a simplified scalable coding system based on the SAO processing. For the encoder side, a lower layer picture derived from the current picture is encoded into a lower layer bitstream, where the lower layer picture has lower spatial resolution or lower picture quality than the current picture. An EL (enhancement layer) picture is generated from the current picture and a reconstructed lower layer picture. The EL SAO information associated with SAO processing applied to the EL picture is generated, where the EL SAO information allows reconstructing the EL picture based on the EL SAO information alone. A scalable bitstream for the enhancement layer is then generated by multiplexing the SAO information with a lower layer scalable bitstream. For the decoder side, the system extracts EL (enhancement layer) SAO information for the enhancement layer and a lower layer scalable bitstream by de-multiplexing the scalable bitstream. An EL picture is reconstructed based on the EL SAO information and a reconstructed lower layer picture is reconstructed based on the lower layer scalable bitstream. A current picture for the enhancement layer is then generated based on the reconstructed lower layer picture and the EL picture.

### BRIEF DESCRIPTION OF THE DRAWINGS

FIG. 1 illustrates an example of prediction structure for a two-layer scalable video encoding system incorporating inter-layer prediction.

FIG. 2 illustrates a block diagram of an exemplary video decoding system incorporating sample adaptive offset (SAO) processing.

FIG. 3 illustrates sample adaptive offset (SAO) processing by partitioning intensities into multiple bands according to band offset (BO) used by the high efficiency video coding (HEVC) standard.

FIG. 4 illustrates the four edge offset (EO) types corresponding to 0-degree, 90-degree, 135-degree and 45-degree used by the high efficiency video coding (HEVC) standard.

FIG. 5 illustrates an example of prediction structure for a two-layer scalable video encoding system incorporating inter-layer sample adaptive offset (SAO) processing.

FIG. 6 illustrates the four highpass edge offset (EO) types corresponding to 0-degree, 90-degree, 135-degree and 45-degree used by inter-layer sample adaptive offset (SAO) processing.

FIG. 7 illustrates SAO information sharing with a neighboring block, where the current CTU (coding tree unit) can reuse SAO parameters of the left or above CTU.

FIG. 8 illustrates coding process to transmit CTU-level SAO information when the current CTU is not merged with the left or above CTU.

FIG. 9 illustrates an example of composite EO type group consisting four EO types used by HEVC and four EO types corresponding to highpass EO processing according to an embodiment of the present invention.

FIG. 10 illustrates an example of composite EO type group consisting two EO types used by HEVC and two EO types corresponding to highpass EO processing according to an embodiment of the present invention.

FIG. 11 illustrates an example of composite EO type group using a syntax flag to select between four EO types used by HEVC and four EO types corresponding to highpass EO processing according to an embodiment of the present invention.

FIG. 12 illustrates an example of composite EO type group using a syntax flag to select between four EO types used by HEVC and two EO types corresponding to highpass EO processing according to an embodiment of the present invention.

FIG. 13 illustrates an example of inter-layer SAO information sharing according to an embodiment of the present invention.

FIG. 14 illustrates an example of SAO information compression by storing SAO information for one CTB for every four CTBs according to an embodiment of the present invention.

FIG. 15 compares basic coding structure between a conventional scalable system and a simplified scalable system incorporating an embodiment of the present invention.

FIG. 16A illustrates a simplified scalable encoder according to an embodiment of the present invention, where the scalable system consists of a base layer and N enhancement layers, and down-sampling and up-sampling are used.

FIG. 16B illustrates an example of a simplified scalable decoder corresponding to the encoder in FIG. 16A.

FIG. 17A illustrates a simplified scalable encoder according to another embodiment of the present invention, where up-sampling filter parameters are incorporated in the scalable bitstream.

FIG. 17B illustrates an example of a simplified scalable decoder corresponding to the encoder in FIG. 17A.

FIG. 18A illustrates a simplified scalable encoder according to yet another embodiment of the present invention, where a switchable filter is applied to the reconstructed lower layer picture.

FIG. 18B illustrates an example of a simplified scalable decoder corresponding to the encoder in FIG. 18A.

FIG. 19 illustrates an exemplary flowchart for a coding system incorporating composite EO type group according to an embodiment of the present invention.

FIG. 20 illustrates an exemplary flowchart for a scalable coding system incorporating inter-layer SAO information prediction or re-use according to an embodiment of the present invention.

FIG. 21 illustrates an exemplary flowchart for a scalable encoding system incorporating simplified scalability using SAO for enhancement layers according to an embodiment of the present invention.

FIG. 22 illustrates an exemplary flowchart for a scalable decoding system incorporating simplified scalability using SAO for enhancement layers according to an embodiment of the present invention.

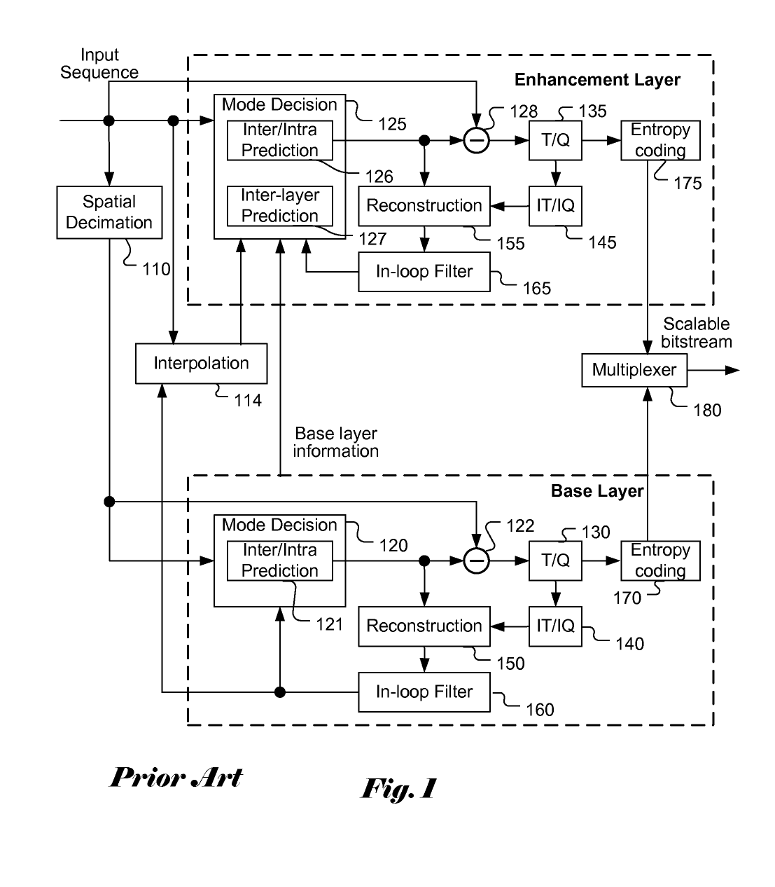

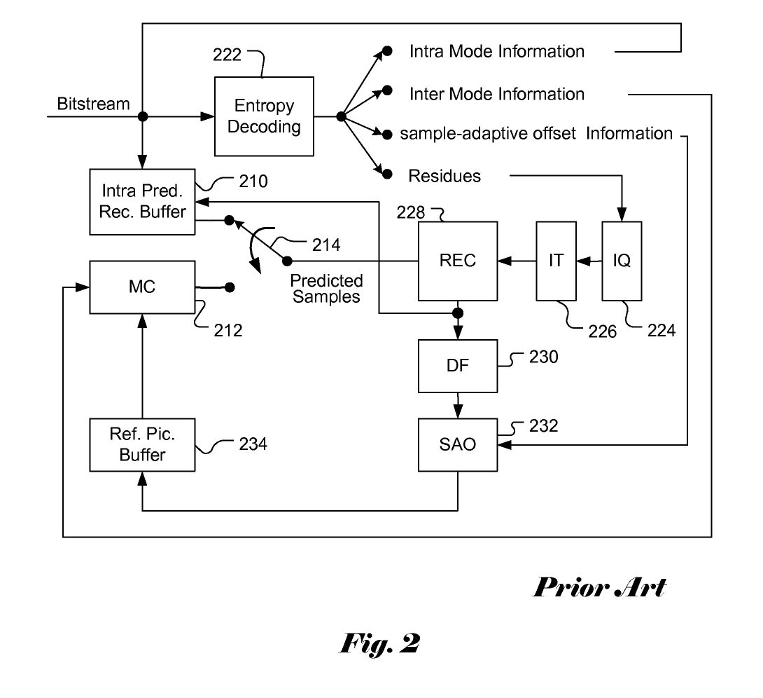

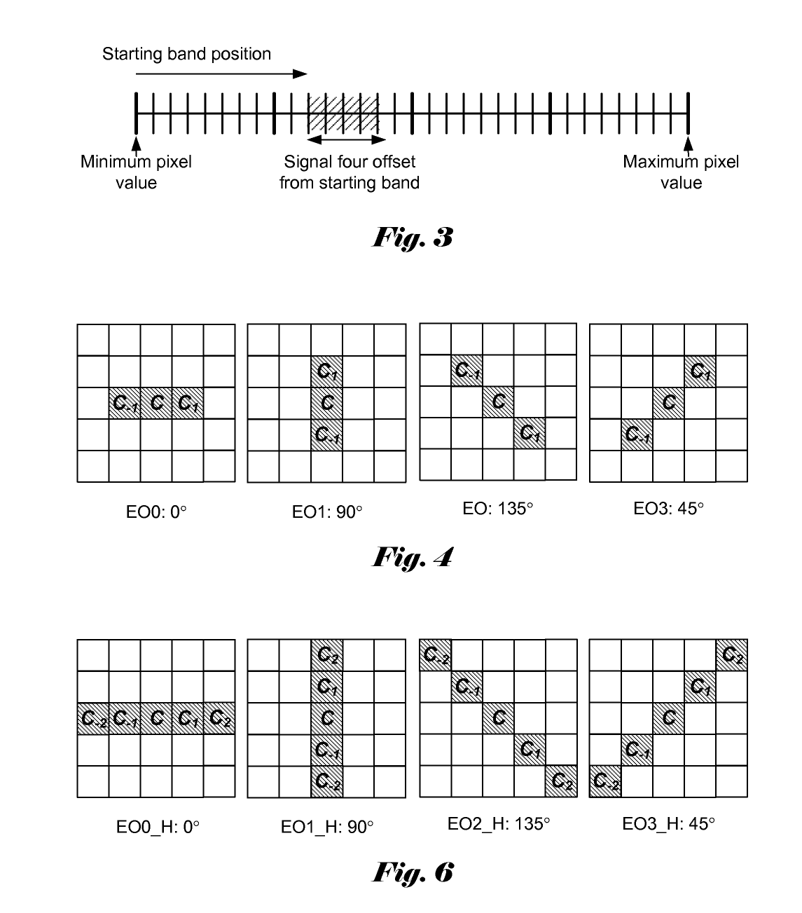

### DETAILED DESCRIPTION OF THE INVENTION

As mentioned before, a highpass SAO processing was introduced for inter-layer scalable video coding. The highpass SAO processing may achieve improved performance for certain video contents. However, the conventional EO based on 3 neighboring pixels may be desired for some applications such as a system compatible with the conventional coder. Accordingly, the present invention discloses means for adaptively exploiting both the conventional SAO pixel classification scheme used for single-layer HEVC coding and the newer SAO pixel classification scheme with highpass processing for inter-layer scalable video coding. Embodiments according to the present invention selects an EO type from a combination of the two classification schemes for applying the SAO processing to the reconstructed picture regions. A method incorporating an embodiment of the present invention includes a signaling scheme to support adaptation at the different layers of the hierarchical bitstream structure. The method can be applied to the SAO processing units of different granularity levels, including CTUs (Coding Tree Units), slices, quadtree regions and the entire picture. Embodiments can be applied to general image and video coding applications. Two different types of embodiments are disclosed to exploit both the conventional SAO for single layer coding and the newer SAO pixel classification scheme with highpass processing for inter-layer scalable video coding.

### Embodiments with Type A EO Classification

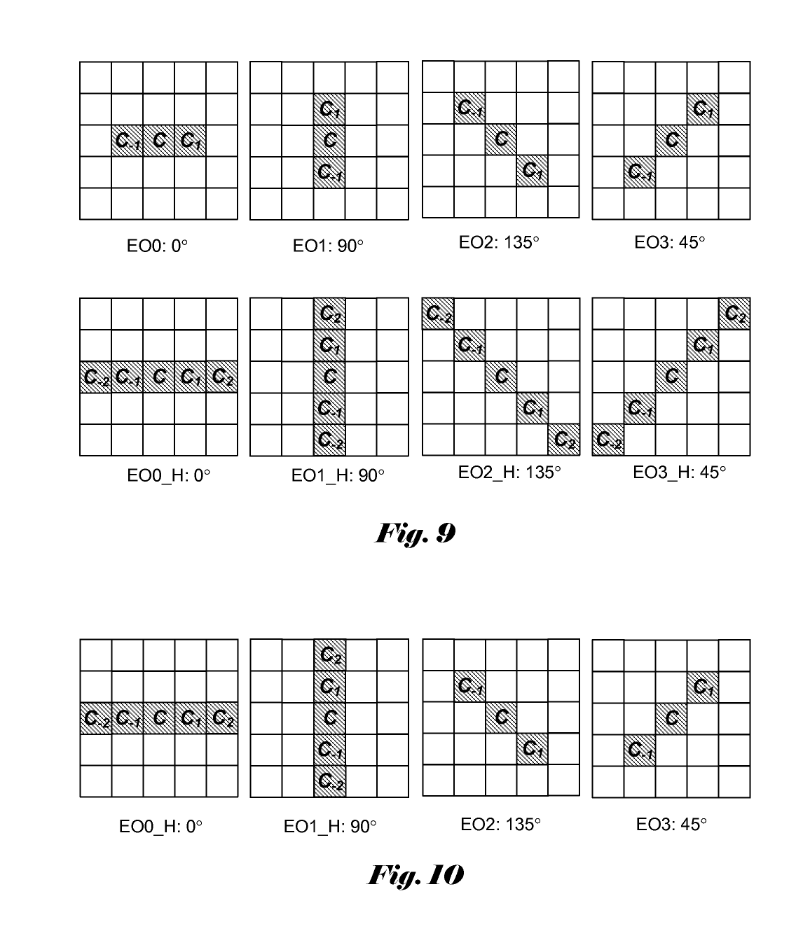

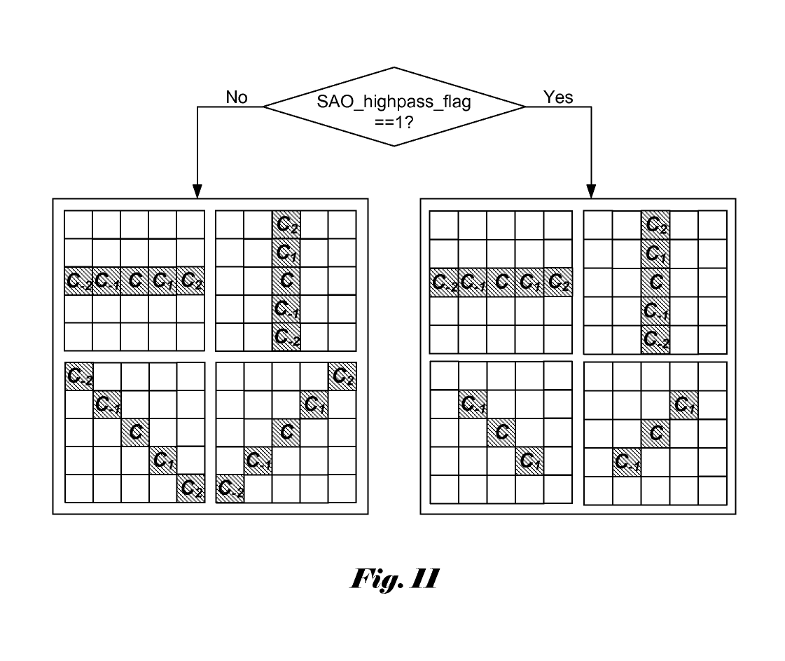

Embodiments according to Type A classification construct a composite set of the EO types to support both the conventional EO pixel classification scheme employed by the single-layer HEVC standard and the newer EO pixel classification scheme with highpass processing. In one embodiment, the composite set of EO types includes all 8 EO types resulted from both classification schemes, as illustrated in FIG. 9. The first four EO types correspond to using the neighboring reconstructed pixels for pixel classification as defined by eqn (1). The other four EO types correspond to using the highpass output of the neighboring reconstructed pixels for pixel classification as defined in eqn (2). In another Type A embodiment, at least one of the conventional EO pixel classification scheme employed by the single-layer HEVC standard and the newer EO pixel classification scheme with highpass processing includes only partial EO types in order to save implementation complexity and overhead information. For example, the composite EO type group may include two diagonal EO types resulted from the HEVC standard and the horizontal and vertical EO types resulted from the new classification scheme using highpass processing as illustrated in FIG. 10.

### Embodiments with Type B EO Classification

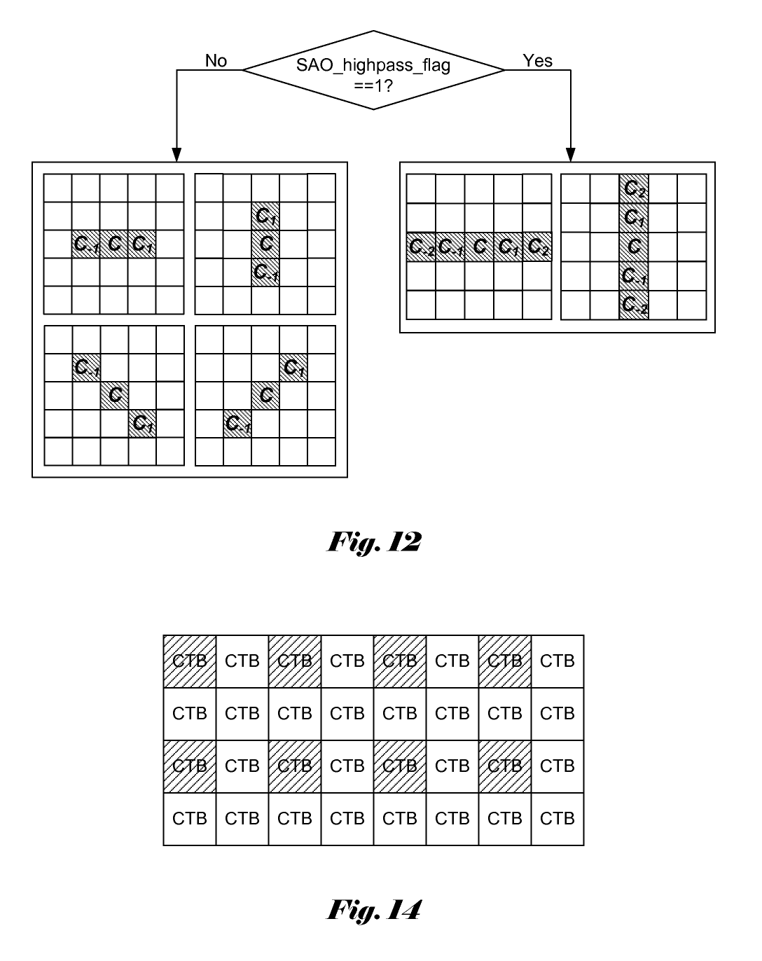

Embodiments according to Type B classification adaptively select an EO type between the conventional pixel classification scheme based on the reconstructed pixels as defined by eqn (1) and the new SAO pixel classification scheme based on the highpass output of the reconstructed pixels as defined by eqn (2). A syntax flag may be used to indicate which EO set is currently being employed in a corresponding SAO processing unit. In one embodiment, the same number (i.e., 4) of the EO types as that of the HEVC standard is adopted for both pixel classification schemes such that the SAO related syntax can be efficiently reused as shown in FIG. 11. In another Type B embodiment, at least one of the two classification schemes only includes partial EO set in order to further save implementation complexity and overhead information. For example, all four EO types are included when the conventional pixel classification scheme is used and only the horizontal and vertical EO types are used when the newer pixel classification scheme is used as shown in FIG. 12.

The method of EO classification using a composite EO type group can be applied to reconstructed pictures in the base layer as well as reconstructed pictures in an enhancement layer. After SAO processing, the SAO-processed reconstructed picture can be stored in a decoded picture buffer for motion-compensated temporal prediction in the scalable video coding system. The reconstructed picture may also correspond to a base layer picture or an enhancement layer picture before or after re-sampling for inter-layer prediction in a next enhancement layer in the scalable video coding system. While highpass filtering according to eqn. (2) is used to derive highpass outputs, weighted outputs based on the current reconstructed pixel and neighboring pixels may also be used. Furthermore, highpass filter may have scaled filter coefficients corresponding to (−1, 1).

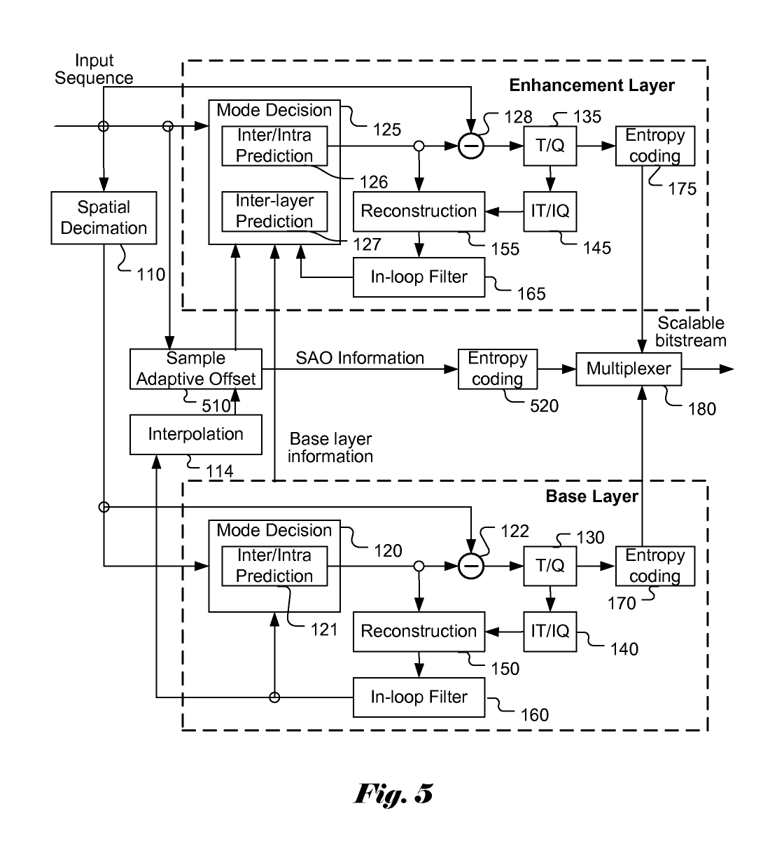

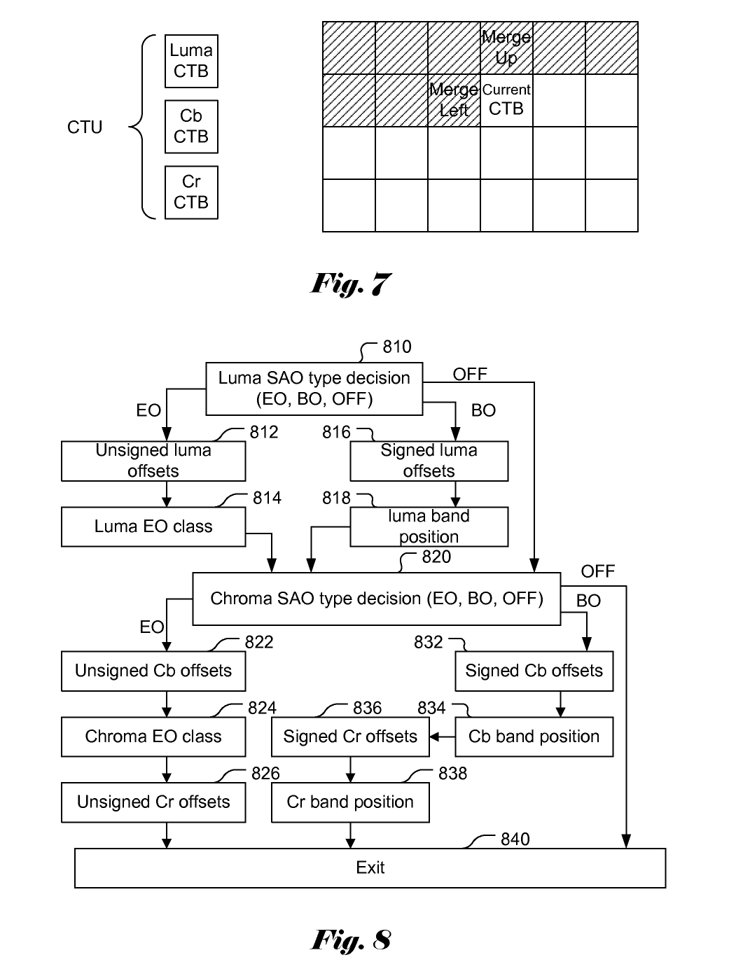

When SAO is used for inter-layer processing, the SAO information has to be incorporated in the bitstream as shown in FIG. 5. In a system with a large number of layers, the inter-layer SAO information may be substantial. Therefore, it is desirable to reduce the side information of SAO for the enhancement layer in scalable video coding. Accordingly, in an embodiment of the present invention, the SAO parameters for a target region in inter-layer SAO can be derived, predicted or merged from the source region in the base layer. The target and source regions are defined as rectangular block in the corresponding region. For example, the BL region can be the whole BL picture, BL coding tree block (CTB) or 4×4 block. The corresponding inter-layer region will be the whole EL picture, EL CTB or 4X×4X block, wherein X corresponds to a scaling factor between the enhancement layer and the base layer. The predicted or merged SAO parameters can be the whole or partial SAO parameters. The BL region can be spatially neighboring regions, temporal co-located regions or the corresponding regions in other layers. For example, the SAO offset values of the base layer can be re-used by the enhancement layer or inter-layer SAO as shown in FIG. 13. For SAO information reuse 1310, the merging of two CTBs in the base layer (1312) is re-used by an enhancement layer (1314) so that the corresponding two EL CTBs are also merged. For SAO information reuse 1320, the SAO type selections (EO and BO) for two BL CTBs in the base layer (1322) is re-used by an enhancement layer (1324) so that the SAO type selections for the corresponding two CTBs are EO and BO respectively. Some coding performance evaluation experiments show that the coding performance may be improved when the SAO type selected by a corresponding CTB in the enhancement layer is different from the SAO type of the base layer CTB, especially in the case when the resolution of the two layers are the same. An embodiment of a multi-layer or scalable system restricts an enhancement layer CTB to select the same SAO type used by a corresponding base layer CTB.

Since the texture of each layer may be very similar, it makes sense to only share the information of SAO Merge flag and SAO type between layers or inter-layer as shown in FIG. 13. In this case, the SAO Merge flags and SAO types of the base layer will be re-used by the inter-layer SAO and the offset values for inter-layer SAO will be signaled. To further reduce side information, embodiments of the present invention use the base layer offset values to predict the inter-layer SAO offset values and only the difference is signaled. To add flexibility and provide options for different video coding profiles, a flag is to enable/disable the predicting/re-using SAO parameters according to one embodiment of the present invention. For example, a flag can be signaled to turn SAO parameters re-using On or Off in the CU level, CTB level, slice header, picture parameter set, adaptation parameter set, picture parameters set, sequence parameter set or video parameter set. Similarly, a syntax flag may also be used to indicate which view is used for the inter-layer SAO parameter prediction or re-using, wherein the syntax element is signaled in sequence parameter set (SPS), video parameter set, picture parameter set (PPS), slice header or coding tree block (CTB).

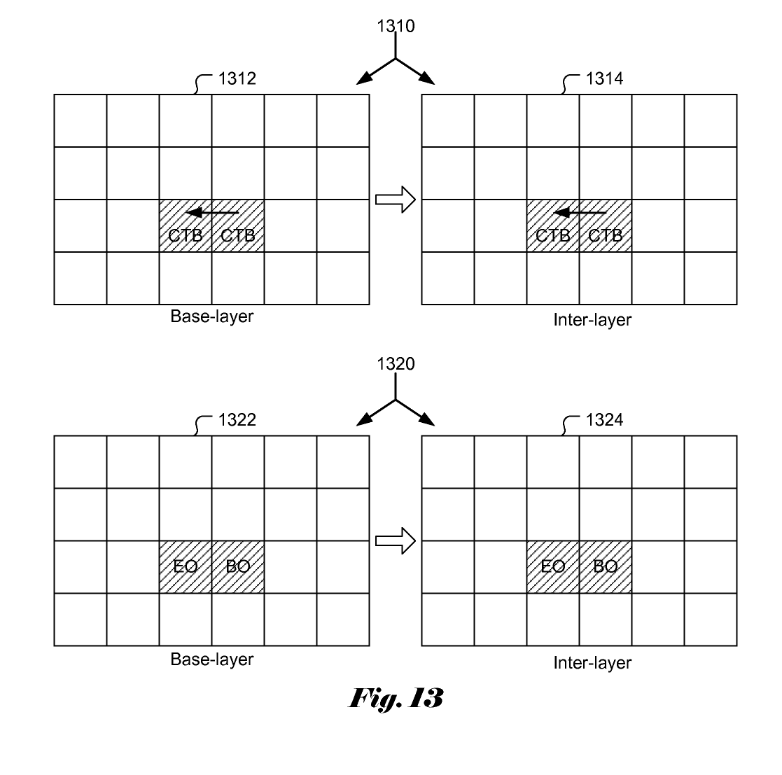

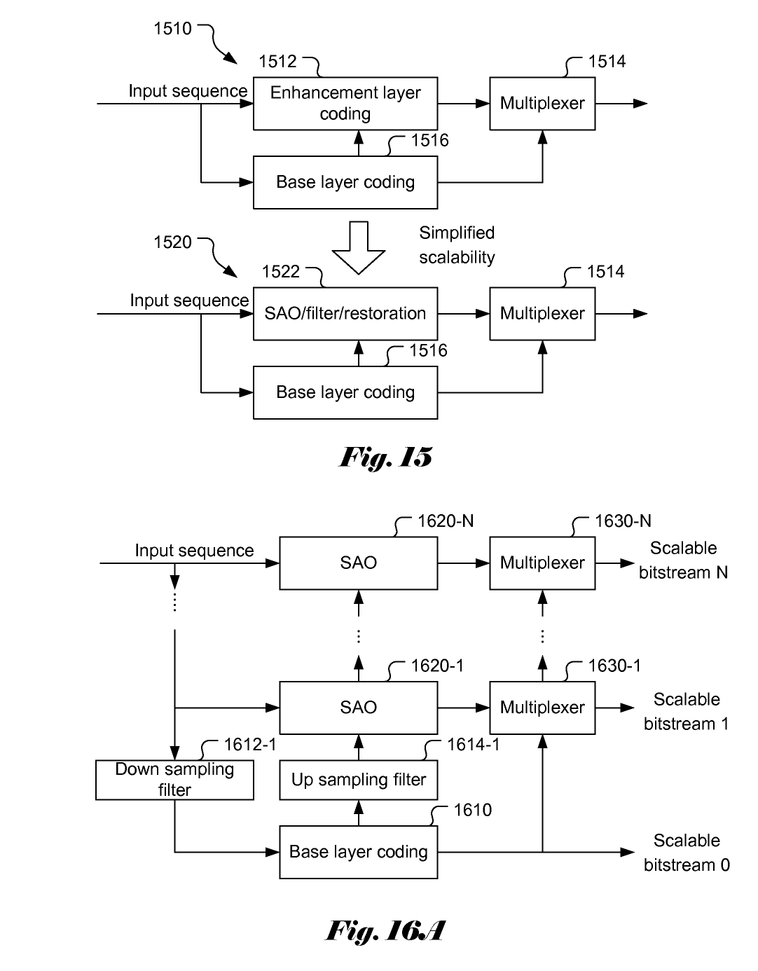

If SAO parameters of the base layer are reused for the inter-layer SAO, the SAO parameters of entire picture or slice will have to be stored for the future usage. This may require additional buffer to store SAO parameters, which will increase the hardware/software cost. To reduce the memory usage, an embodiment according to the present invention compresses SAO parameters. The SAO parameters of the base layer can be down sampled. For example, the SAO parameters of one representative CTB in every SAO parameters compression unit are stored, where each SAO parameters compression unit contains multiple CTBs. The representative CTB can be any one within the SAO parameters compression unit. For example, if the SAO parameters compression unit contains four CTBs, the size of SAO buffer can be reduced by a factor of four. As shown in FIG. 14, only the SAO parameters of the representative CTB (indicated by a line-filled box) are stored. Furthermore, only partial SAO information such as merge-left-flag, merge-up-flag or SAO type may need to be stored. In this case, the offset values can be discarded without buffering. Partial SAO information re-using is based on the assumption which the picture contents of different layers are similar while the lighting condition or quantization coefficients between layers may be different. For example, only the syntax related to the interlayer-SAO parameters merging and SAO type are predicted or merged. In this case, only sao_merge_left_flag, sao_merge_up_flag, sao_type_idx_luma and sao_type_idx_chroma, sao_eo_class_luma, sao_eo_class_chroma are predicted or merged. In another example, only the syntax related to interlayer-SAO parameters merging are predicted or merged. In this case, only sao_merge_left_flag and sao_merge_up_flag are predicted or merged. In yet another example, only the syntax related to interlayer-SAO type are predicted or merged. In this case, only sao_type_idx_luma, sao_type_idx_chroma, sao_eo_class_luma, and sao_eo_class_chroma are predicted or merged. Also, only the syntax related to interlayer-SAO offset values can be predicted or merged. In this case, only sao_offset_abs, sao_offset_sign, sao_band_position, are predicted or merged. The partial SAO parameters can also be any combination of sao_merge_up_flag, sao_merge_left_flag, sao_type_idx_luma, sao_type_idx_chroma, sao_eo_class_luma, sao_eo_class_chroma and sao_band_position.

The performance of a video coding system incorporating an embodiment of the present invention according to Type B classification with a full set of conventional EO types and a full set EO classification with highpass processing is compared with the performance of a conventional system based on HTM-12.0 as shown in Table 2 and Table 3. The performance comparison is based on different sets of test data listed in the first column. The BD-rate differences are shown for individual video components (Y, U and V) and overall video data (YUV). A negative value in the BD-rate indicates that the present invention has a better performance. As shown in Table 2, the BD-rates for individual components (Y, U and V) and overall video data (YUV) incorporating an embodiment of the present invention are reduced by 0.4% to 1.1% for All Intra Main profile configuration and 0.3% to 0.4% for Random Access Main profile configuration. As shown in Table 3, the BD-rates for individual components (Y, U and V) and overall video data (YUV) incorporating an embodiment of the present invention are reduced by 0.3% to 1.3% for Low delay B picture Main profile configuration and 1.1% to 1.5% for Low delay P picture Main profile configuration

TABLE 2

| | All Intra Main | | | | Random Access Main | | | |
|---|---|---|---|---|---|---|---|---|
| | Y | U | V | YUV | Y | U | V | YUV |
| Class A | −0.80% | −0.60% | −0.30% | −0.80% | −0.80% | −0.80% | −0.40% | −0.80% |
| (8 bit) | | | | | | | | |
| Class B | −0.40% | −0.70% | −0.70% | −0.50% | −0.60% | −0.30% | −0.40% | −0.60% |
| Class C | −0.10% | −0.70% | −1.20% | −0.30% | −0.10% | −0.40% | −0.80% | −0.20% |
| Class D | −0.10% | −0.90% | −0.80% | −0.20% | 0.00% | 0.00% | −0.10% | 0.00% |
| Class E | −0.70% | −2.50% | −2.40% | −1.00% | | | | |
| Overall | −0.40% | −1.00% | −1.10% | −0.50% | −0.30% | −0.30% | −0.40% | −0.30% |

TABLE 3

| | Low delay B Main | | | | Low delay P Main | | | |
|---|---|---|---|---|---|---|---|---|
| | Y | U | V | YUV | Y | U | V | YUV |
| Class B | −0.60% | −0.40% | −0.40% | −0.60% | −1.70% | −0.40% | −0.70% | −1.50% |
| Class C | 0.00% | −0.40% | −0.50% | −0.10% | −0.50% | −0.50% | −1.10% | −0.60% |
| Class D | 0.00% | −0.30% | 0.60% | 0.00% | −0.20% | 0.00% | 0.00% | −0.20% |
| Class E | −0.80% | −5.50% | −4.90% | −1.60% | −1.90% | −6.10% | −5.50% | −2.60% |
| Overall | −0.30% | −1.30% | −1.00% | −0.50% | −1.10% | −1.40% | −1.50% | −1.20% |

The performance of a video coding system with high efficient 10-bit (HE10) coding configuration incorporating an embodiment of the present invention according to Type B classification with a full set of conventional EO types and a full set EO classification with highpass processing is compared with the performance of a conventional system based on HTM-12.0 as shown in Table 4 and Table 5. As shown in Table 4, the BD-rates for individual components (Y, U and V) and overall video data (YUV) incorporating an embodiment of the present invention are reduced by 0.4% to 1.3% for All Intra HE10 profile configuration and 0.3% to 0.5% for Random Access HE10 profile configuration. As shown in Table 5, the BD-rates for individual components (Y, U and V) and overall video data (YUV) incorporating an embodiment of the present invention are reduced by 0.3% to 1.4% for Low delay B picture HE10 profile configuration and 1.1% to 2.1% for Low delay P picture HE10 profile configuration.

TABLE 4

| | All Intra HE10 | | | | Random Access HE10 | | | |
|---|---|---|---|---|---|---|---|---|
| | Y | U | V | YUV | Y | U | V | YUV |
| Class A | −0.90% | −0.70% | −0.70% | −0.90% | −0.80% | −0.60% | −0.50% | −0.80% |
| (8 bit) | | | | | | | | |
| Class B | −0.40% | −0.80% | −0.80% | −0.50% | −0.50% | −0.40% | −0.90% | −0.50% |
| Class C | −0.10% | −0.90% | −1.30% | −0.30% | 0.00% | −0.40% | −0.60% | −0.10% |
| Class D | −0.10% | −1.10% | −0.90% | −0.30% | 0.10% | −0.30% | 0.00% | 0.00% |
| Class E | −0.70% | −3.10% | −3.20% | −1.20% | | | | |
| Overall | −0.40% | −1.30% | −1.30% | −0.60% | −0.30% | −0.40% | −0.50% | −0.30% |

TABLE 5

| | Low delay B HE10 | | | | Low delay P HE10 | | | |
|---|---|---|---|---|---|---|---|---|
| | Y | U | V | YUV | Y | U | V | YUV |
| Class B | −0.50% | −0.70% | −0.80% | −0.60% | −1.80% | −1.20% | −1.20% | −1.70% |
| Class C | 0.00% | −0.20% | −0.50% | −0.10% | −0.50% | −1.00% | −1.20% | −0.60% |
| Class D | 0.00% | −0.30% | 0.60% | 0.10% | −0.10% | −0.30% | 0.90% | −0.10% |
| Class E | −0.80% | −5.80% | −5.40% | −1.70% | −2.10% | −7.10% | −7.20% | −3.10% |
| Overall | −0.30% | −1.40% | −1.20% | −0.50% | −1.10% | −2.10% | −1.80% | −1.30% |

The performance of a scalable video coding system incorporating an embodiment of the present invention according to Type B classification with a full set of conventional EO types and a full set EO classification with highpass processing is compared with the performance of a conventional scalable system based on SHM-3.0 (Scalable HEVC Test Model version 3.0) as shown in Table 6. The comparisons have been performed for various coding configurations including All Intra with 2× scaling (AI HEVC 2×), All Intra with 1.5× scaling (AI HEVC 1.5×), Random Access with 2× scaling (RA HEVC 2×), Random Access with 1.5× scaling (RA HEVC 1.5×), Random Access with SNR scaling (RA HEVC SNR), Low delay P picture with 2× scaling (LD-P HEVC 2×), Low delay P picture with 1.5× scaling (LD-P HEVC 1.5×), Low delay P picture with SNR scaling (LD-P HEVC SNR), Low delay B picture with 2× scaling (LD-B HEVC 2×), Low delay B picture with 1.5× scaling (LD-B HEVC 1.5×), and Low delay B picture with SNR scaling (LD-B HEVC SNR). As shown in Table 6, the BD-rates for individual components (Y, U and V) incorporating an embodiment of the present invention can be reduced by as much as 2.3% for overall performance and as much as 2.7% for the enhancement layer performance.

TABLE 5

| | AI HEVC 2x | | | AI HEVC 1.5x | | | | | |
|---|---|---|---|---|---|---|---|---|---|
| | Y | U | V | Y | U | V | | | |
| Class A | 0.00% | −0.40% | −0.30% | | | | | | |
| Class B | −0.40% | −0.50% | −0.50% | −0.40% | −0.50% | −0.50% | | | |
| Overall | −0.30% | −0.50% | −0.40% | −0.40% | −0.50% | −0.50% | | | |
| (Test vs Ref) | | | | | | | | | |
| EL only | −0.40% | −0.60% | −0.50% | −0.50% | −0.60% | −0.60% | | | |
| (Test vs Ref) | | | | | | | | | |
| | RA HEVC 2x | | | RA HEVC 1.5x | | | RA HEVC SNR | | |
| | Y | U | V | Y | U | V | Y | U | V |
| Class A | −0.10% | −0.10% | 0.00% | | | | −1.90% | −0.90% | −0.50% |
| Class B | −0.50% | 0.00% | −0.20% | −0.50% | −0.10% | −0.10% | −1.00% | −0.60% | −0.70% |
| Overall | −0.40% | 0.00% | −0.10% | −0.50% | −0.10% | −0.10% | −1.30% | −0.60% | −0.70% |
| (Test vs Ref) | | | | | | | | | |
| EL only | −0.40% | −0.10% | −0.20% | −0.60% | −0.10% | −0.20% | −1.70% | −1.00% | −1.00% |
| (Test vs Ref) | | | | | | | | | |
| | LD-P HEVC 2x | | | LD-P HEVC 1.5x | | | LD-P HEVC SNR | | |
| | Y | U | V | Y | U | V | Y | U | V |
| Class A | −0.60% | −0.40% | −0.10% | | | | −3.10% | −1.20% | −0.80% |
| Class B | −1.20% | −0.20% | −0.30% | −1.20% | −0.20% | −0.50% | −2.00% | −0.90% | −1.10% |
| Overall | −1.00% | −0.30% | −0.20% | −1.20% | −0.20% | −0.50% | −2.30% | −1.00% | −1.00% |
| (Test vs Ref) | | | | | | | | | |
| EL only | −1.10% | −0.30% | −0.30% | −1.30% | −0.20% | −0.50% | −2.70% | −1.40% | −1.40% |
| (Test vs Ref) | | | | | | | | | |
| | LD-B HEVC 2x | | | LD-B HEVC 1.5x | | | LD-B HEVC SNR | | |
| | Y | U | V | Y | U | V | Y | U | V |
| Class A | −0.10% | −0.10% | 0.00% | | | | −1.70% | −0.70% | −0.30% |
| Class B | −0.40% | 0.10% | −0.10% | −0.40% | 0.00% | −0.30% | −0.80% | −0.40% | −0.60% |
| Overall | −0.30% | 0.00% | −0.10% | −0.40% | 0.00% | −0.30% | −1.10% | −0.50% | −0.50% |
| (Test vs Ref) | | | | | | | | | |
| EL only | −0.30% | 0.00% | −0.10% | −0.30% | 0.10% | −0.10% | −1.30% | −0.70% | −0.70% |
| (Test vs Ref) | | | | | | | | | |

FIG. 5 illustrates a 3D coding system using SAO processing to reduce the distortion of the inter-layer prediction derived from the reconstructed BL. The enhancement layer undergoes typical Inter/Intra prediction, transform and quantization. In addition, the inter-layer SAO processing is applied to the interpolated inter-layer prediction derived from the BL. Accordingly, the system complexity of the conventional scalable system is rather high. In order to simplify the processing, embodiments according to the present invention use SAO processing to replace at least one coding processing, such as Inter/Intra prediction, transform or quantization in the enhancement layer. In one example, the whole coding process for the enhancement layer is replaced by the SAO processing. In conventional applications such as HEVC, the SAO is used to compensate the offsets of the reconstructed video, where SAO is located within the reconstruction loop. Therefore, the SAO processing won't be able to provided reconstructed signal without applying the decoding process (i.e., inverse transform, dequantization, and Inter/Intra predicted reconstruction). Nevertheless, when SAO is applied to an underlying video without the conventional coding process, video reconstruction is possible by applying the SAO process alone. The enhancement layer may further use filtering or restoration to further improve the quality of the reconstructed enhancement layer. However, the use of filtering or restoration is optional. When the filtering or restoration is used, reconstruction of the enhancement layer can still be achieved by using the enhancement layer SAO information alone. Therefore, SAO can be used as a means for simple scalable coding. The information associated with the SAO processing with optional filtering/restoration in each layer can be multiplexed with a lower layer bitstream to form a scalable bitstream for the current layer.

The SAO processing for the enhancement layers may be the same. However, different SAO processing may also be applied to the enhancement layers. For example, one layer may use EO types and another layer may use BO types for classification. The associated SAO information such as SAO types and offset values will be incorporated in the scalable bitstream for the current layer. In another embodiment, one layer may use one or more EO (edge offset) types selected from horizontal and vertical directions and another layer may use one or more EO types selected from 45-degree and 135-degree directions. In yet another embodiment, one enhancement layer may use first EO (edge offset) types and another enhancement layer may use second EO types. The first EO types may determine first EO classification based on a current reconstructed pixel and two neighboring reconstructed pixels of the EL picture, and the second EO types may determine second EO classification based on high-pass filtering outputs from the current reconstructed pixel and a number of neighboring reconstructed pixels.

FIG. 15 compares basic coding structure between a conventional scalable system and a simplified scalable system. System 1510 corresponds to a conventional scalable coding system, where the enhancement layer is coded using enhancement layer coding 1512 and the base layer is coded using base layer coding 1516. The bitstreams are combined using multiplexer 1514. For simplified scalable coding system 1520, the enhancement layer coding is replaced by SAO processing 1522, which may optionally include filtering or restoration. Spatial down sampling and up sampling between different layers may be included optionally.

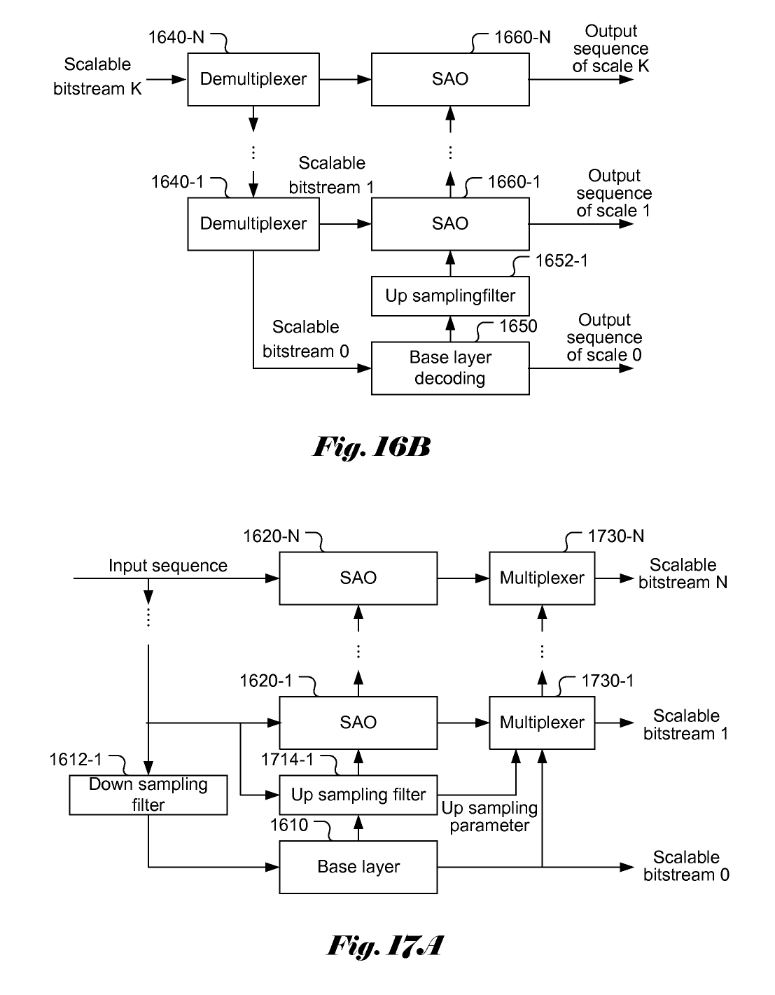

FIG. 16A illustrates a simplified scalable encoder according to an embodiment of the present invention, where the scalable system consists of a base layer and N enhancement layers. In this example, down sampling filter (e.g., 1612-1) and up sampling filter (e.g., 1614-1) are used between layers. The base layer is coded using base layer coding 1610 and enhancement layers are processed by SAO processing (1620-1, . . . , 1620-N). Multiplexers (1630-1, . . . , 1630-N) are used to form scalable bitstream 1 through scalable bitstream N for enhancement layers. FIG. 16A illustrates an example to replace the enhancement coding by SAO processing and the complexity is substantially reduced.

FIG. 16B illustrates an example of a simplified scalable decoder corresponding to the encoder in FIG. 16A according to an embodiment of the present invention. Demultiplexers (1640-1, . . . , 1640-N) are used to extract scalable bitstream 0 through scalable bitstream K. An up sampling filter (e.g., 1652-1) is used to up sample a lower layer to an upper layer. The base layer is decoded using base layer decoding 1650 and the enhancement layers are processed by SAO processing (1660-1, . . . , 1660-N) to produce scalable sequence outputs for layer 0 to layer K.

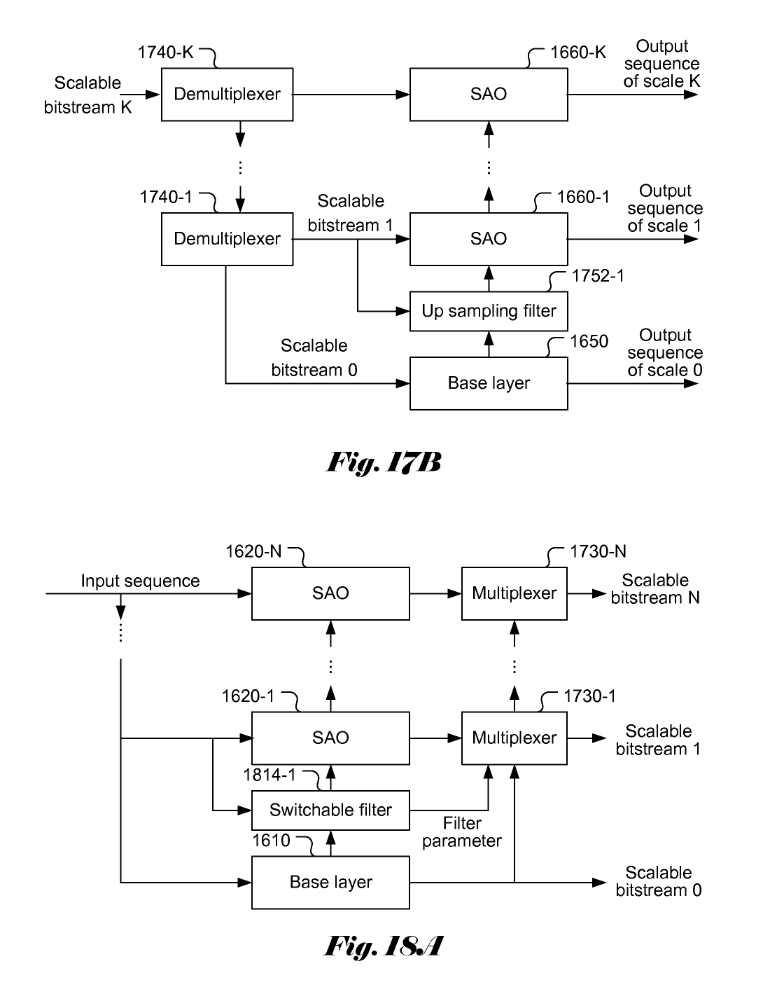

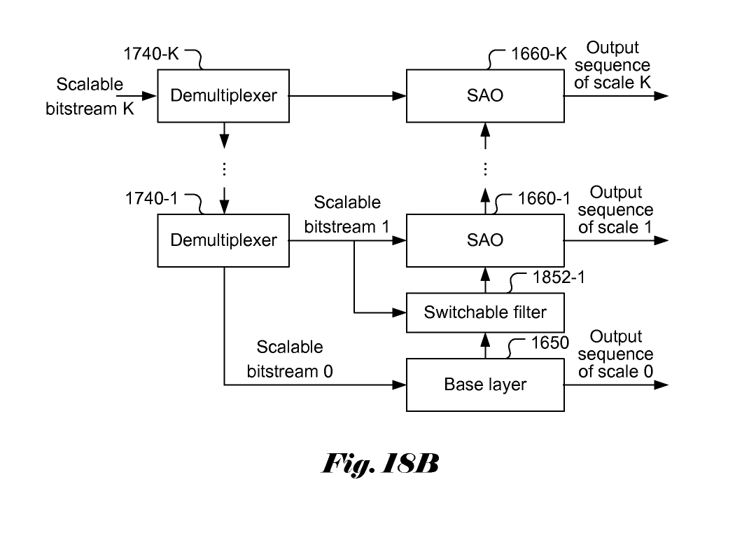

FIG. 17A illustrates a simplified scalable encoder according to another embodiment of the present invention, where the encoder is substantially the same as the encoder in FIG. 16A except that up sampling filter (e.g., 1714-1) is adaptively selected and the up sampling parameter are coded in the bitstream. In this example, up sampling parameters associated with the up sampling filter (e.g., 1714-1) are incorporated in a respective multiplexers (e.g., 1730-1) to form a scalable bitstream.

FIG. 17B illustrates an example of a simplified scalable decoder corresponding to the encoder in FIG. 17A. Demultiplexers (1740-1, . . . , 1740-K) are used to extract scalable bitstream 0 through scalable bitstream K, where the enhancement layer bitstreams include up sampling parameters. The up sampling parameters extracted are used for a respective up sampling filter (e.g., 1752-1) to up sample the lower layer to the upper layer.

FIG. 18A illustrates a simplified scalable encoder according to yet another embodiment of the present invention, where the encoder is similar to the encoder in FIG. 17A except that down and up sampling filters are not used and a switchable filter (e.g., 1814-1) is used between layers. The filter parameters are coded in the bitstream. The encoder shown in FIG. 18 is similar to a SNR scalable system, where the spatial resolutions is the same for all layers.

FIG. 18B illustrates an example of a simplified scalable decoder corresponding to the encoder in FIG. 18A. Demultiplexers (1740-1, . . . , 1740-K) are used to extract scalable bitstream 0 through scalable bitstream K, where the enhancement layer bitstreams include filter parameters. The filter parameters extracted are used for a respective switchable filter (e.g., 1852-1) to filter the prediction signal from a lower layer.

FIGS. 16 through 18 illustrate three examples of simplified scalable systems. These drawings are not meant for an exhaustive illustration of all possible configurations for simplified scalable system. Other processing to improve video quality, such as filtering and restoration, may also added to the SAO processing. In addition, instead of replacing all enhancement coding steps by SAO processing, partial coding steps may be replaced by the SAO processing.

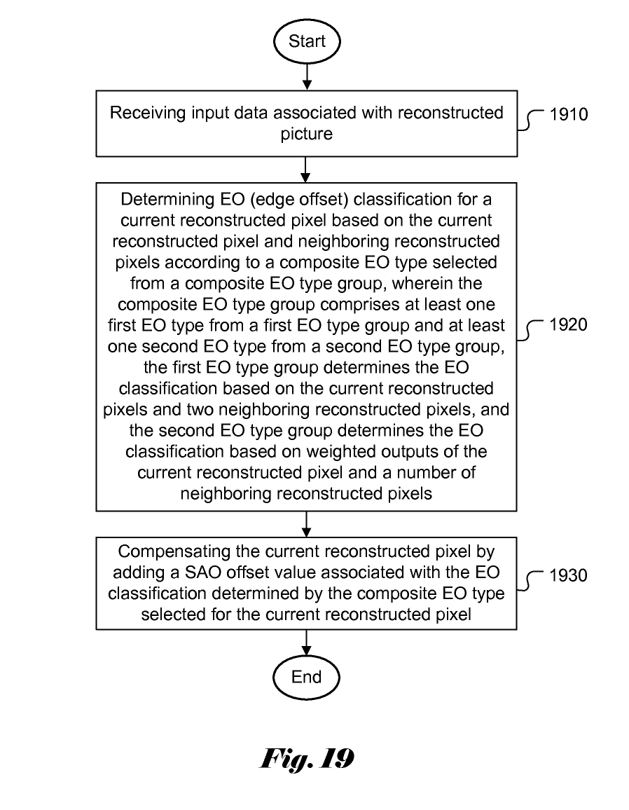

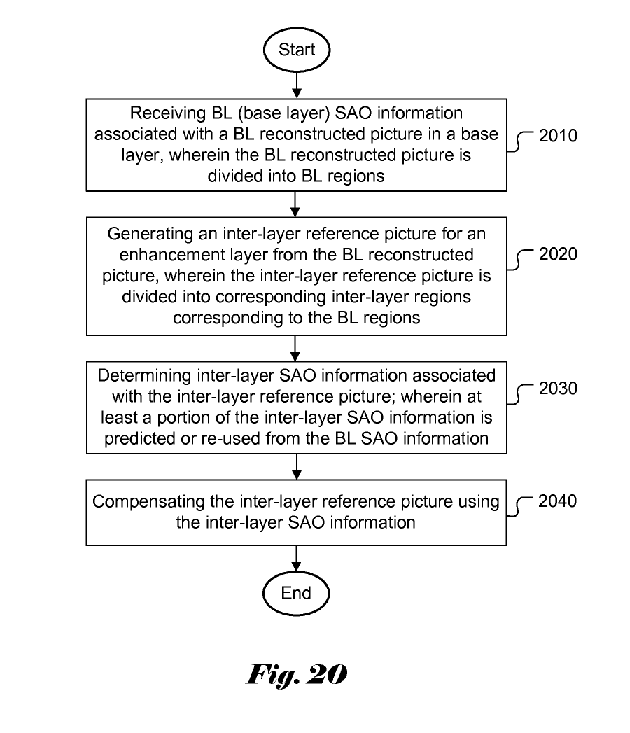

FIG. 19 illustrates an exemplary flowchart of SAO processing using composite EO type group according to an embodiment of the resent invention. The system receives input data associated with reconstructed picture as shown in step 1910. The reconstructed picture may be retrieved from memory or received from a processor. An EO (edge offset) classification for a current reconstructed pixel is determined based on the current reconstructed pixel and neighboring reconstructed pixels according to a composite EO type selected from a composite EO type group as shown in step 1920. The composite EO type group comprises at least one first EO type from a first EO type group and at least one second EO type from a second EO type group. The first EO type group determines the EO classification based on the current reconstructed pixel and two neighboring reconstructed pixels. The second EO type group determines the EO classification based on weighted outputs of the current reconstructed pixel and a number of neighboring reconstructed pixels. The current reconstructed pixel is compensated by adding a SAO offset value associated with the EO classification determined by the composite EO type selected for the current reconstructed pixel as shown in step 1930.

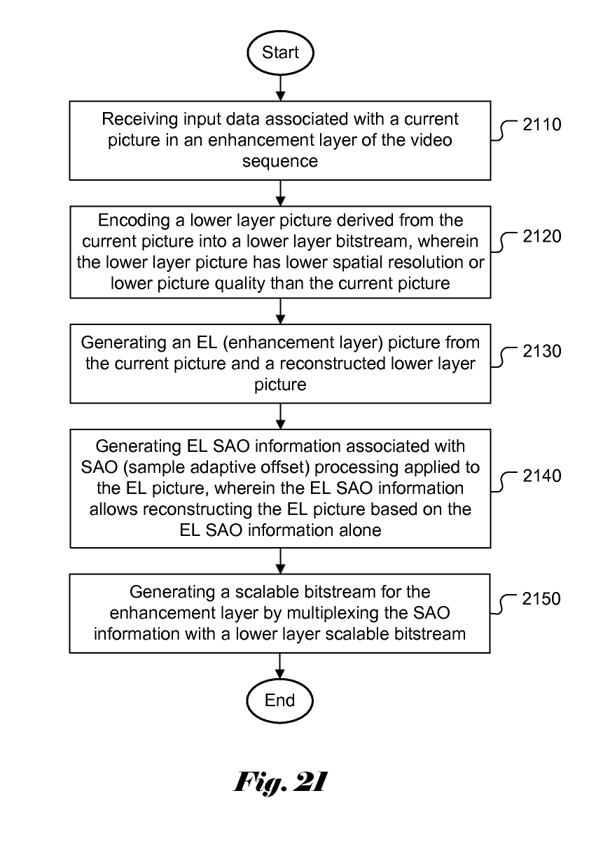

FIG. 20 illustrates an exemplary flowchart of SAO processing for a scalable video coding system using inter-layer SAO parameter prediction or re-using in a scalable video coding according to an embodiment of the resent invention. The BL (base layer) SAO information associated with a BL reconstructed picture in a base layer is received as shown in step 2010, wherein the BL reconstructed picture is divided into BL regions. An inter-layer reference picture for an enhancement layer is generated from the BL reconstructed picture as shown in step 2020, wherein the inter-layer reference picture is divided into corresponding inter-layer regions corresponding to the BL regions. The inter-layer SAO information associated with the inter-layer reference picture is determined as shown in step 2030, wherein at least a portion of the inter-layer SAO information is predicted or re-used from the BL SAO information. The inter-layer reference picture is compensated using the inter-layer SAO information as shown in step 2040.

FIG. 21 illustrates an exemplary flowchart of a simplified scalable encoder using SAO processing for enhancement layers according to an embodiment of the present invention. Input data associated with a current picture in an enhancement layer of the video sequence is received as shown in step 2110. A lower layer picture derived from the current picture is encoded into a lower layer bitstream, wherein the lower layer picture has lower spatial resolution or lower picture quality than the current picture in step 2120. An EL (enhancement layer) picture is generated from the current picture and a reconstructed lower layer picture in step 2130. The EL SAO information associated with SAO (sample adaptive offset) processing applied to the EL picture is generated in step 2140, where the EL SAO information allows reconstructing the EL picture based on the EL SAO information alone. A scalable bitstream for the enhancement layer is generated by multiplexing the SAO information with a lower layer scalable bitstream in step 2150.

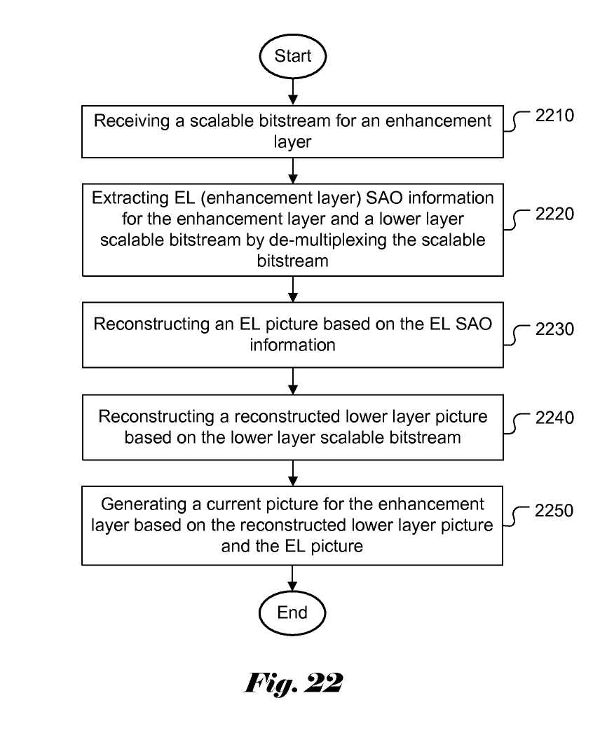

FIG. 22 illustrates an exemplary flowchart of a simplified scalable decoder using SAO processing for enhancement layers according to an embodiment of the resent invention. A scalable bitstream for an enhancement layer is received in step 2210. The EL (enhancement layer) SAO information for the enhancement layer and a lower layer scalable bitstream are extracted by de-multiplexing the scalable bitstream in step 2220. An EL picture is reconstructed based on the EL SAO information in step 2230. A reconstructed lower layer picture is reconstructed based on the lower layer scalable bitstream in step 2240. A current picture for the enhancement layer is generated based on the reconstructed lower layer picture and the EL picture in step 2250.

The flowcharts shown above are intended to illustrate examples of SAO processing according to the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of SAO (sample-adaptive offset) processing for a single-layer video coding system or a scalable video coding system, the method comprising:
receiving input data associated with a reconstructed picture;
determining EO (edge offset) classification for a current reconstructed pixel based on the current reconstructed pixel and neighboring reconstructed pixels according to a composite EO type selected from a composite EO type group, wherein the composite EO type group comprises at least one first EO type from a first EO type group and at least one second EO type from a second EO type group, the first EO type group determines the EO classification based on the current reconstructed pixel and two neighboring reconstructed pixels, and the second EO type group determines the EO classification based on weighted outputs of the current reconstructed pixel and a number of neighboring reconstructed pixels; and
compensating the current reconstructed pixel by adding a SAO offset value associated with the EO classification determined by the composite EO type selected for the current reconstructed pixel.

2. The method of claim 1, wherein the reconstructed picture is divided into non-overlapped regions and SAO parameter set associated with the SAO processing for each region is signaling in a video bitstream.

3. The method of claim 2, wherein the region corresponds to an entire picture or a CTU (coding tree unit), or the region corresponds to a quadtree partition region when the reconstructed picture is divided using quadtree partition.

4. The method of claim 1, wherein the reconstructed picture corresponds to a base layer picture or an enhancement layer picture, and SAO-processed reconstructed picture is stored in a decoded picture buffer for motion-compensated temporal prediction in the scalable video coding system.

5. The method of claim 1, wherein the reconstructed picture corresponds to a base layer picture or an enhancement layer picture before or after re-sampling for inter-layer prediction in a next enhancement layer in the scalable video coding system.

6. The method of claim 1, wherein the weighted outputs correspond to high-pass filtering outputs having scaled filter coefficients corresponding to (−1, 2, 1) or (−1, 1) and the weighted outputs use the current reconstructed pixel and four neighboring reconstructed pixels.

7. The method of claim 1, wherein the composite EO type group includes four first EO types from the first EO type group and four second EO types from the second EO type group, wherein the four first EO types and the four second EO types correspond to pixel patterns in 0°, 90°, 45° and 135° directions.

8. The method of claim 1, wherein the composite EO type group includes two first EO types from the first EO type group and two second EO types from the second EO type group, wherein the two first EO types correspond to pixel patterns in 45° and 135° directions and the two second EO types correspond to pixel patterns in 0° and 90° directions.

9. The method of claim 1, wherein a syntax flag is signaled to indicate whether the composite EO type is selected from the first EO type group or the second EO type group in a corresponding coding structure.

10. The method of claim 9, wherein the syntax flag is signaled in a video parameter set, sequence parameter set (SPS), picture parameter set (PPS), slice header or coding tree unit (CTU).

11. The method of claim 9, wherein at least one of the EO types is removed according to the syntax flag.

12. A method of inter-layer sample-adaptive offset (SAO) processing using inter-layer SAO parameter prediction or re-using in a scalable video coding, the method comprising:
receiving BL (base layer) SAO information associated with a BL reconstructed picture in a base layer, wherein the BL reconstructed picture is divided into BL regions;
generating an inter-layer reference picture for an enhancement layer from the BL reconstructed picture, wherein the inter-layer reference picture is divided into corresponding inter-layer regions corresponding to the BL regions;
determining inter-layer SAO information associated with the inter-layer reference picture, wherein at least a portion of the inter-layer SAO information is predicted or re-used from the BL SAO information; and
compensating the inter-layer reference picture using the inter-layer SAO information.

13. The method of claim 12, wherein a syntax flag to enable/disable SAO parameter prediction or reusing is explicitly signaled, wherein the syntax flag is signaled in sequence parameter set (SPS), video parameter set, picture parameter set (PPS), slice header or coding tree block (CTB).

14. The method of claim 12, wherein only partial inter-layer SAO information is predicted or re-used from the BL SAO information, wherein the partial inter-layer SAO information corresponds to inter-layer SAO merging syntax element, inter-layer SAO type, inter-layer SAO offset values, or any combination thereof.

15. The method of claim 12, wherein the BL SAO information is stored in a compressed form for the inter-layer SAO parameter prediction or re-using.

16. The method of claim 150, wherein only partial BL SAO information is stored.

17. A method of scalable video decoding for a video sequence, the method comprising:
receiving a bitstream for an enhancement layer;
extracting EL (enhancement layer) SAO information for the enhancement layer and a lower layer bitstream by de-multiplexing the bitstream;
reconstructing an EL picture based on the EL SAO information;
reconstructing a reconstructed lower layer picture based on the lower layer bitstream; and
generating a current picture for the enhancement layer based on the reconstructed lower layer picture and the EL picture.

18. The method of claim 17, wherein the method further comprising:
extracting up-sampling filter parameters from the bitstream for the enhancement layer; and
up-sampling the reconstructed lower layer picture using an up-sampling filter based on the up-sampling filter parameters before said generating the current picture.

19. The method of claim 17, wherein the method further comprising:
extracting switchable filter parameters from the bitstream for the enhancement layer; and
filtering the reconstructed lower layer picture using a switchable filter based on the switchable filter parameters before said generating the current picture.

20. The method of claim 17, wherein the lower layer picture corresponds to a base layer picture or a lower layer enhancement picture.
